(19) United States
(12) Patent Application Publication
(10) Pub. No.: US 2013/0036121 A1
(43) Pub. Date: Feb. 7, 2013

(54) SYSTEM AND METHOD FOR RECOMMENDING BLOG

(71) Applicants: Yeon Jeong KIM, Seongnam-si (KR); Joongoo LEE, Seongnam-si (KR)

(72) Inventors: Yeon Jeong KIM, Seongnam-si (KR); Joongoo LEE, Seongnam-si (KR)

(73) Assignee: NHN CORPORATION, Seongnam-si (KR)

(21) Appl. No.: 13/564,411

(22) Filed: Aug. 1, 2012

(30) Foreign Application Priority Data
Aug. 1, 2011 (KR) 10-2011-0076501
Aug. 1, 2011 (KR) 10-2011-0076502
Aug. 2, 2011 (KR) 10-2011-0076839

(51) Int. Cl. G06F 17/30

(52) U.S. Cl. 707/740; 707/737; 707/E17.032; 707/E17.014

(57) ABSTRACT

Provided is a system and method for recommending a blog. The blog recommendation system includes a segmentation unit to classify blogs according to at least one category of age and gender of a user, an extraction unit to extract a plurality of search terms retrieved by a user corresponding to the category, a cluster unit to learn the search terms into a document in the classified blogs and to group the search terms into at least one cluster, a generation unit to generate a blog pool related to the search terms included in the cluster, and a recommendation unit to provide the user with at least one blog in the blog pool as a recommended blog.

### CROSS-REFERENCE TO RELATED APPLICATIONS

This application claims priority to and the benefit of Korean Patent Application No. 10-2011-0076502, filed on Aug. 1, 2011, Korean Patent Application No. 10-2011-0076501, filed on Aug. 1, 2011, and Korean Patent Application No. 10-2011-0076839, filed on Aug. 2, 2011, which are hereby incorporated by reference for all purposes as if fully set forth herein.

### BACKGROUND OF THE INVENTION

1. Field of the Invention

Exemplary embodiments of the present invention relate to a system and a method for recommending a blog among users to activate a blog network.

2. Discussion of the Background

With the development of communications technology, people are utilizing gradual advances in web-based tools to develop social relationships. In particular, a social networking service (SNS) based on the Internet allows users actively participating social relations among users.

As a representative SNS, a blog, a portmanteau of web and log, is a website through which users can post varying interests, at any convenient time. Although such a blog is an individual-centric website, the blog provides a collaborative feature for dynamic interactions among users, thereby allowing users sharing common interests to visit their respective blogs, and updating blog conveniently.

To add a neighbor blog, users typically are required to search for an interesting blog on a site providing a blog service to be selected as a neighbor, or to select an interesting blog among blogs classified according to subjects on the site. However, a conventional blog service has an insufficient number of channels for users to search for a new blog and to add the blog as a neighbor with ease.

Conventionally, an approach for recommending a user with preferred blog by analyzing emotions, preferences, personalities, tastes, and status changes of the user is introduced. However, this conventional method simply relies on preferences of the user obtained via outmoded questions and answers.

Accordingly, the present invention provides a system and a method for recommending a blog suitable to an age and a gender of respective users among numerous blogs by providing accurate, continuous, and automatic investigation of primary interests of users according to the age and the gender of the respective users.

The above information disclosed in this Background section is only for enhancement of understanding of the background of the invention and therefore it may contain information that does not form any part of the prior art nor what the prior art may suggest to a person of ordinary skill in the art.

### SUMMARY OF THE INVENTION

Exemplary embodiments of the present invention provide a system and method for providing a blog recommending logic and specific standards in order to recommend an accurate blog to a user.

Additional features of the invention will be set forth in the description which follows, and in part will be apparent from the description, or may be learned by practice of the invention.

Exemplary embodiments of the present invention provide a system. The system includes a segmentation unit configured to classify blogs according to at least one category of an age and a gender of a user. The system includes an extraction unit configured to extract a plurality of search terms retrieved by a user corresponding to the category. The system includes a cluster unit configured to collect the search terms into a document in the classified blogs and to group the search terms into at least one cluster. The system includes a generation unit configured to generate a blog pool related to the search terms of the cluster. The system also includes a recommendation unit configured to provide the user with at least one blog in the blog pool as a recommended blog, wherein the blog in the blog pool is stored in the storage device.

Exemplary embodiments of the present invention provide a system for recommending a blog. The system also includes a storage device configured to store posts in one blog read by each blogger comprising another blog and a retention time which comprising a measure of time spent by each blogger in the one blog. The system includes a generation unit configured to compare read posts with posts read by a user and configured to generate a blog pool comprising the read posts similar to the posts read by the user. The system includes a calculation unit configured to calculate behavioral similarity between a blog of the blog pool and the user using the retention time. The system also includes a recommendation unit configured to provide the user with a blog of the blog pool as a recommended blog based on the behavioral similarity.

Exemplary embodiments of the present invention provide a system for recommending a blog. The system includes a subscription ratio calculation unit configured to calculate a service subscription ratio of each blogger comprising a blog with respect to a community service in each category, wherein community services are classified. The system includes a similarity calculation unit configured to calculate community similarity by comparing service subscription ratios in each category between a user that is a subject blogger and bloggers comprising a first blogger. The system includes a recommendation unit to provide the user with a blog of the first blogger as a recommended blog based on the community similarity, wherein the blog of the first blogger is stored in the storage device.

Exemplary embodiments of the present invention provide a method using a processor for recommending a blog. The method includes classifying blogs according to at least one category of an age and a gender of a user. The method also includes extracting a plurality of search terms retrieved by a user corresponding to the category. The method also includes collecting, by the processor, the search terms into a document in the classified blogs for grouping the search terms into at least one cluster. The method includes generating a blog pool related to the search terms of the cluster. The method also includes providing the user with at least one blog in the blog pool as a recommended blog.

Exemplary embodiments of the present invention provide a method using a processor for recommending a blog. The method includes storing posts in one blog read by each blogger comprising a first blog and a retention time of the each blogger stayed in the one blog. The method also includes comparing the posts with posts read by a user and generating a blog pool comprising the posts similar to the posts read by the user. The method includes calculating, by the processor, behavioral similarity between a blog of the blog pool and the user using the retention time. The method also includes providing the user with a blog of the blog pool as a recommended blog based on the behavioral similarity.

Exemplary embodiments of the present invention provide a method using a processor for recommending a blog. The method includes calculating a service subscription ratio of each blogger comprising a blog with respect to a community service in each category, wherein community services are classified. The method also includes calculating, by the processor, community similarity by comparing service subscription ratios in each category between a user that is a subject blogger among the bloggers and a first blogger. The method includes providing the user with a blog of the first blogger as a recommended blog based on the community similarity.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a diagram of a blog recommendation system according to exemplary embodiments of the present invention.

FIG. 2 is a diagram illustrating a configuration of a blog recommendation system which recommends a blog related to an interest by an age and a gender of a user according to exemplary embodiments of the present invention.

FIG. 3 illustrates a logic for determining a recommended blog according to exemplary embodiments of the present invention.

FIGS. 4 and 5 illustrate a service section on a screen for displaying a recommended blog according exemplary embodiments of the present invention.

FIG. 6 is a flowchart of a process for illustrating a blog recommendation method which recommends a blog related to an interest by an age and a gender of a user according to exemplary embodiments of the present invention.

FIG. 7 is a block diagram illustrating a configuration of a blog recommendation system which recommends a blog having a similar behavior pattern to that of a user according to exemplary embodiments of the present invention.

FIG. 8 illustrates a diagram for determining behavioral similarity with a user according exemplary embodiments of the present invention

FIGS. 9 and 10 illustrate a service section on a screen for displaying a recommended blog according to exemplary embodiments of the present invention.

FIG. 11 is a flowchart of a process for illustrating a blog recommendation method which recommends a blog having a similar behavior pattern to that of a user according to exemplary embodiments of the present invention.

FIG. 12 is a block diagram illustrating a configuration of a blog recommendation system which recommends blogs having similar category-specific distributions of community services subscribed to according to exemplary embodiments of the present invention.

FIG. 13 illustrates a diagram for determining similarity with respect to community services subscribed to according to exemplary embodiments of the present invention.

FIGS. 14 and 15 illustrate a service section on a screen for displaying a recommended blog according to exemplary embodiments of the present invention.

FIG. 16 is a flowchart of a process for illustrating a blog recommendation method which recommends a blog having similar category-specific distribution of community services subscribed to according to exemplary embodiments of the present invention.

FIG. 17 is a diagram of hardware that can be used to implement exemplary embodiments of the present invention.

### DETAILED DESCRIPTION OF THE ILLUSTRATED EMBODIMENTS

The invention is described more fully hereinafter with reference to the accompanying drawings, in which exemplary embodiments of the invention are shown. This invention may, however, be embodied in many different forms and should not be construed as limited to the exemplary embodiments set forth herein. Rather, these exemplary embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It will be understood that when an element or layer is referred to as being “on” or “connected to” another element or layer, it can be directly on or directly connected to the other element or layer, or intervening elements or layers may be present. In contrast, when an element or layer is referred to as being “directly on” or “directly connected to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

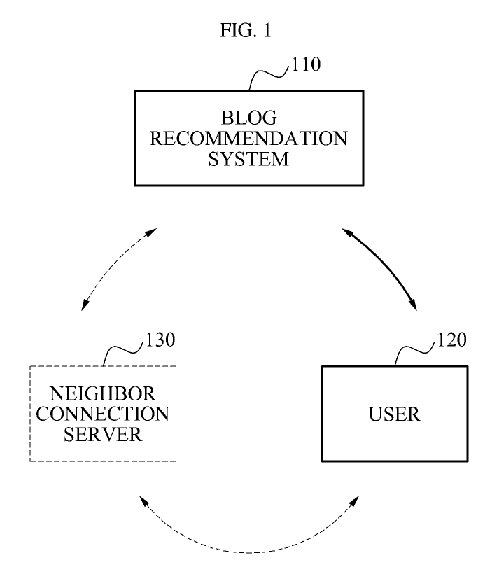

FIG. 1 illustrates a process of a blog recommendation system according to exemplary embodiments of the present invention. FIG. 1 illustrates a blog recommendation system 110 which recommends a new blog to a user so as to expand a neighbor network of the user.

In the exemplary embodiments of the present invention, the blog recommendation system 110 may be combined with a blog server (not shown) providing a blog service into a single system or be configured in a form of a system separate from the blog server to interwork with the blog server. Here, a blog may refer to a community-based web service to provide an uploading feature by a user, through the Internet. The blog service may include a blog connection service to enable users to visit blogs of other users, a service of introducing a blog of a user to various areas, and a service of offering update information on a neighbor blog.

In the exemplary embodiments detailed in the following, the blog recommendation system 110 can be combined with a blog server into a single system and provides a blog service, without being limited thereto. A structure or type of the blog recommendation system 110 may be changed or modified by way of configurations.

Referring to FIG. 1, the blog recommendation system 110 according to exemplary embodiments may provide a service of recommending a blog of a user to another user 120 connected through a network. That is, the blog recommendation system 110 may select a blog satisfying a specific condition and provide the selected blog to the user 120 as a recommended blog.

The blog recommendation system 110 may be linked to a neighbor connection server 130 which sets up a neighbor relationship between an internal blog and an external blog and may select a recommended blog from the internal blog and/or external blog. Here, the internal blog may be a blog of a user subscribing to a blog service managed by the blog server associated with the blog recommendation system 110, and the external blog may be a blog of a user subscribing to a service not managed by the blog server associated with the blog recommendation system 110. Further, the neighbor connection server 130 serves to provide a set up feature of a neighbor relationship with an external blog based on a request of a blogger running an internal blog, and to provide the blogger with information on the external blog set up as a neighbor relationship.

In exemplary embodiments, the blog recommendation system 110 may classify blogs into segments according to an age and a gender of a user, extract continued interests by segments, and recommend a blog suitable for corresponding interest of the user. For example, interests determined by an age and a gender may be extracted based on a search term, and a blog suitable for a user may be selected and recommended based on interest matching and a quality grade of a blog.

In exemplary embodiments, the blog recommendation system 110 may recommend a blog having a similar interest based on behavioral similarity between blogs. For example, an appropriate blog for a user may be selected and recommended based on the behavioral similarity which is obtained using retention times and read posts in recently visited blogs.

In exemplary embodiments, the blog recommendation system 110 may recommend a blog having similar interests between bloggers. For example, interest similarity may be determined by comparing category-specific distributions of community services subscribed to by bloggers and may be used to select and recommend a blog having a similar interest to that of a user. The blog recommendation system 110 may identify a community service subscribed to by each blogger in association with a community server (not shown) providing a community service. Here, the community server may denote various clubs or groups supported on the Internet, for example, an online café. Further, the community server may define and classify community services according to a plurality of categories and manage the community services by categories. According to exemplary embodiments, community-specific distribution of community services (hereinafter, referred to as “cafés”) subscribed to by a blogger may be used to estimate interests similarity among bloggers.

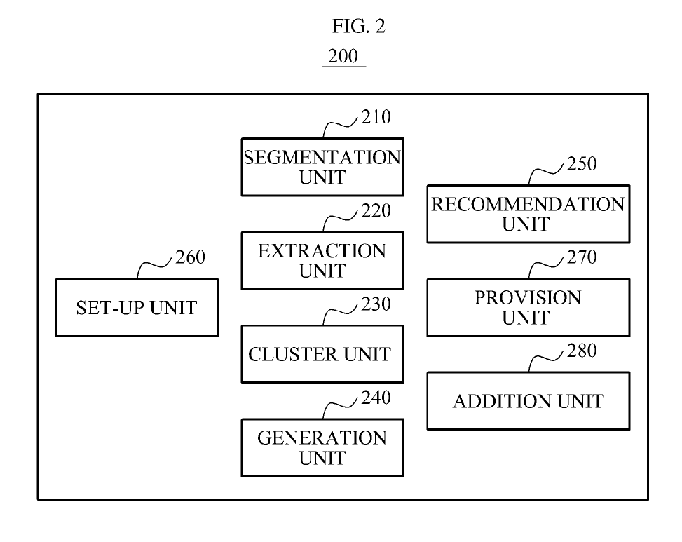

FIG. 2 is a block diagram illustrating a configuration of a blog recommendation system 200 which recommends a blog about an interest by an age and a gender of a user according to the exemplary embodiments of the present invention. The blog recommendation system 200 according to the exemplary embodiments may include a segmentation unit 210, an extraction unit 220, a cluster unit 230, a generation unit 240, a recommendation unit 250, a set-up unit 260, a provision unit 270, and an addition unit 280, by way of a configuration.

The segmentation unit 210 may serve to classify blogs according to at least one category of an age and a gender, wherein each blog group in each category is hereinafter referred to as a “segment”. For example, to expand a neighbor network of a user, continual interests of users in a category may be analyzed by segments and a blog about a subject may be recommended.

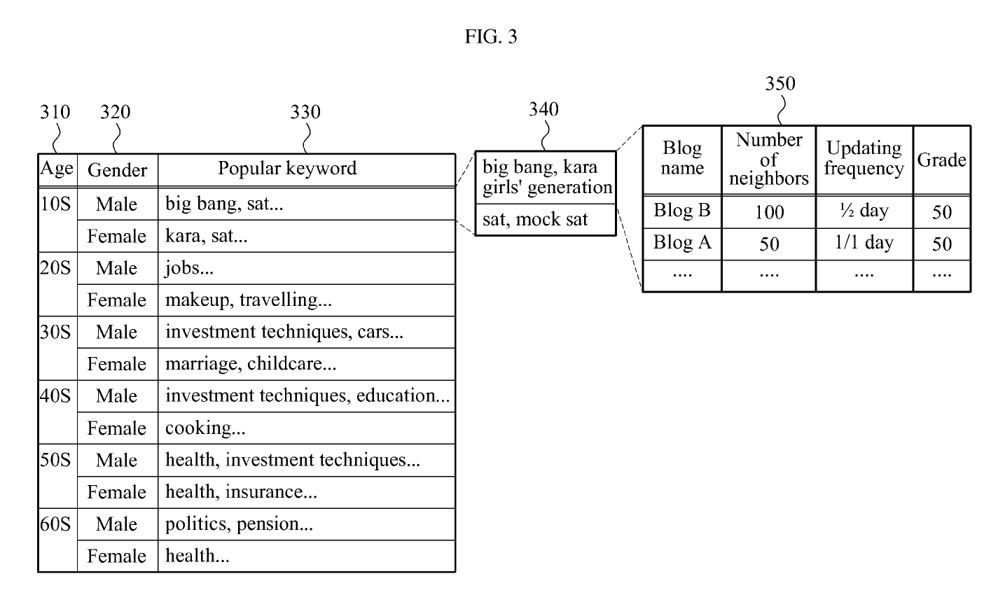

The extraction unit 220 may extract search terms continuously retrieved by users corresponding to certain age and/or gender, in order to analyze interests of the users by categories. Here, the extraction unit 220 may extract a popular search term input a number of times greater than or equal to a predetermined number of times among search terms recently input by the users over a certain period, for example, over a one year period, in association with a search server (not shown). Here, the popular search term which is continuously retrieved for a period of recent time may be extracted using a cumulative query count by a period, for example, a weekly or monthly cumulative query count, for which a keyword is input in a search window of a search service provided by the search server. For example, a seasonal search term intensively retrieved over a short period time or a search term temporarily popular may be excluded from the popular search term. That is, the extraction unit 220 extracts a popular search term retrieved at a cumulative query count of certain number of times or more over a long period of time, excluding search terms popular over a short period time. As shown in FIG. 3, the extraction unit 220 may maintain a table by matching a popular search term 330 to each category divided into the age 310 and the gender 320 and update information on the table on a regular period.

The cluster unit 230 may learn the search terms extracted by categories into a document in a blog corresponding to a segment of a corresponding category and group the terms into at least one cluster. In detail, the cluster unit 230 may group the search terms into a cluster based on a repeated display count that is a number of times the search terms are repeated in documents which include common search terms. Here, a document related grade is calculated with respect to a search term in each category by the following Equation 1, and then search terms having a document related grade of a predefined threshold value or higher may be defined as one cluster.

Document related grade=Number of repeated display times of search term×total number of documents/number of documents including common search terms [Equation 1]

That is, the cluster unit 230 multiplies a repeated display count, which is a number of times a search term being repeated in documents which include the same search term by a total number of documents in the same segment, and divides a resulting value by a number of the documents which include the same search term. Then, search terms having a resulting grade which is a threshold value or higher may be grouped into the same cluster. Here, as shown in FIG. 3, the cluster 340 may be maintained through being matched to a corresponding category classified into the age 310 and the gender 320.

The generation unit 240 may generate a blog pool related to a search term included in a cluster with respect to a category of an age and/or a gender. The generation unit 240 may generate a blog pool with respect to a category by extracting blogs which have documents including more search terms included in the cluster and are aligned with respect to one subject. For example, the generation unit 240 may generate a blog pool by extracting blogs in which at least a certain proportion of keywords found in documents correspond to search terms included in one to cluster. Here, as shown in FIG. 3, the blog pool 350 may be maintained through being matched to a category classified into the age 310 and the gender 320.

The recommendation unit 250 may determine at least one blog from the blog pool to be a recommended blog and provide a user with the determined recommended blog. According to exemplary embodiments, the recommendation unit 250 may calculate a quality grade of each blog included in the blog pool and determine a recommended blog based on the quality grade. For example, the recommendation unit 250 may calculate a quality grade of a blog using at least one of a number of neighbors adding the blog as a neighbor and a frequency of updating content in the blog. The quality grade may be defined as Equation 2.

Quality grade=Number of neighbors×content upgrading frequency (number/day) [Equation 2]

In determining a recommended blog, for example, the recommendation unit 250 may determine blogs having a quality grade of a threshold value or higher from the blog pool as recommendations and provide at least one of the recommendations as a recommended blog. Alternatively, the recommendation unit 250 may determine at least one blog having a higher quality grade from the blog pool to be a recommendation and provide the recommendation as a recommended blog. Further, the recommendation unit 250 may determine a blog which can be selected as a recommended blog from the blog pool to be a recommendation. Accordingly, the set-up unit 260 sets up whether a recommended blog is allowed to be selected in association with each blog, based on a request of a blogger. Here, when a blogger prefers that his/her blog not be selected as a recommended blog, the set-up unit 260 may provide an option feature which enables the blog not to be included in a neighbor recommendation pool. Concisely, the recommendation unit 250 may exclude a blog which a user prefers not to be selected as a recommended blog in the blog pool and select a recommendation among blogs which allow selection as a recommended blog. The recommendation unit 250 may determine a recommendation from the blog pool based on a quality grade and provide the determined blog to a user as a recommended blog.

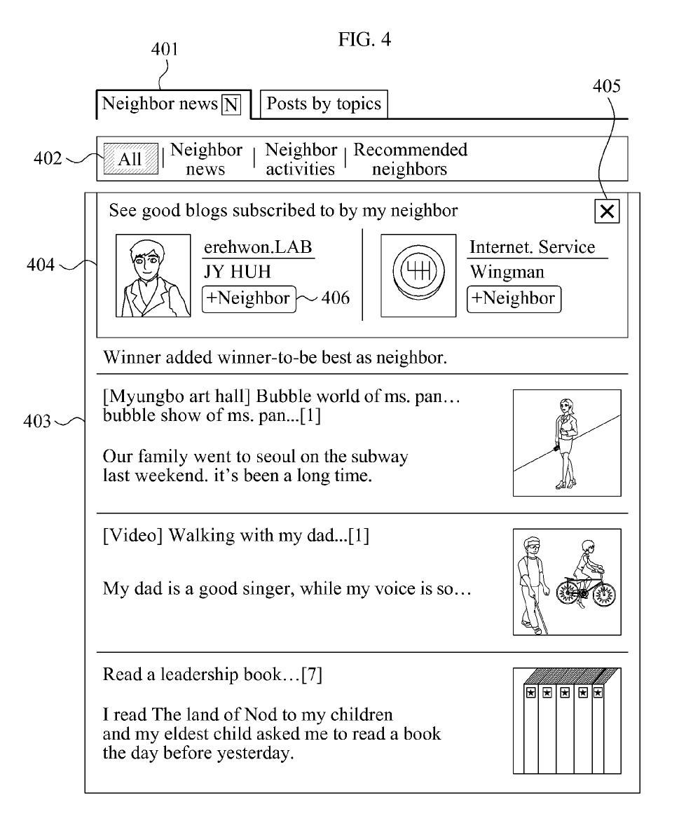

The provision unit 270 may provide a neighbor news page displaying a record of activities of a user with respect to a neighbor blog. Here, the neighbor news page may denote a webpage providing a list of neighbor blogs having a record of recent activities and information on a corresponding neighbor blog, for example, a blog name, a blogger nickname and a recently updated post, so as to easily identify a record of activities of a neighbor blog set up as a neighbor of the user and to facilitate visit to a neighbor blog. Here, the recommendation unit 250 may display a list of recommended blogs through the neighbor news page on which only a predetermined number of blogs having a higher quality grade among the recommendations may be displayed on the list of the recommended blogs. For example, as shown in FIG. 4, when an ‘All’ menu 402 corresponding to a view all is selected from a neighbor news tab 401 providing the neighbor news page, the neighbor news tab 401 may provide a neighbor news section 403 displaying a record of activities of a neighbor blog and a recommended neighbor section 404 displaying blog information on a recommended blog. Here, the recommended neighbor section 404 may be displayed on a top of the neighbor news section 403. The blog information displayed on the recommended neighbor section 404 may include at least one of a blog name or nickname, a blog title, a profile image, a recently registered content, and a frequently registered topic or tag in registering content. The recommended neighbor section 404 may be initially displayed in a spread view and provide an icon 405 to support a fold or close feature and a neighbor add menu 406 for setting up a neighbor relationship with a recommended blog. Further, when folded, the recommended neighbor section 404 may be displayed as a one-line message or an icon indicating that the section 404 is an area where a recommended blog is displayed.

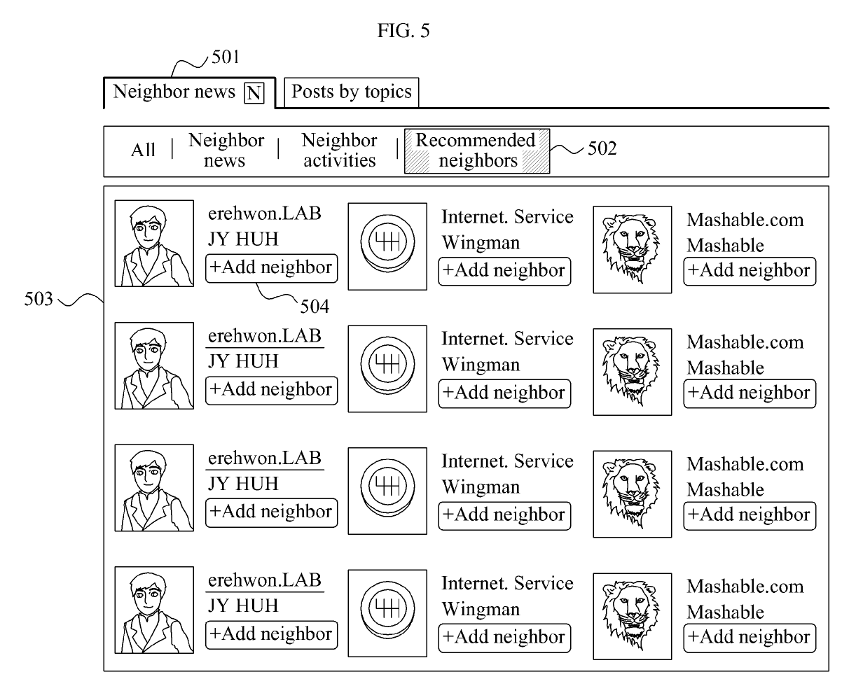

Further, the provision unit 270 may provide a recommended neighbor page displaying a list of recommended blogs. Here, the recommended neighbor page may denote a webpage providing a list of recommended blogs and blog information so that a user easily recognizes a subject or context of a recommended blog. For example, the recommendation unit 250 may display the list of the recommended blogs through the recommended neighbor page on which all blogs determined to be recommendations may be displayed on the list of the recommended blogs. For example, as shown in FIG. 5, when a ‘Recommended Neighbors’ menu 502 is selected, to view a recommended neighbor page, from a neighbor news tab 501 providing a neighbor news page, the neighbor news tab 501 may provide a recommended neighbor section 503 displaying a list of recommended blogs and blog information. Here, the blog information displayed on the recommended neighbor section 503 may include at least one of a blog name or nickname, a blog title, a profile image, a recently registered content, and a frequently registered topic or a tag in registering content. For example, among the blog information, a blog name, a blog title and a profile image may be displayed, and a recently registered content and a frequently registered subject or tag in registering content may be additionally displayed. Further, the recommended neighbor section 503 may provide a neighbor add menu 504 for setting up a neighbor relationship with a recommended blog.

The addition unit 280 may set up a neighbor relationship between a recommended blog and a user when the user makes a request for setting up a neighbor relationship with respect to the recommended blog, and add the recommended blog as a neighbor blog of the user.

The blog recommendation system 200 having the foregoing configuration may classify blogs according to an age and a gender, extract continual interests by each segment, and recommend a blog suitable for a subject. Moreover, for example, interests by an age and a gender may be extracted based on a search term, and a blog suitable for a user may be selected and recommended based on interest matching and a quality grade of a blog.

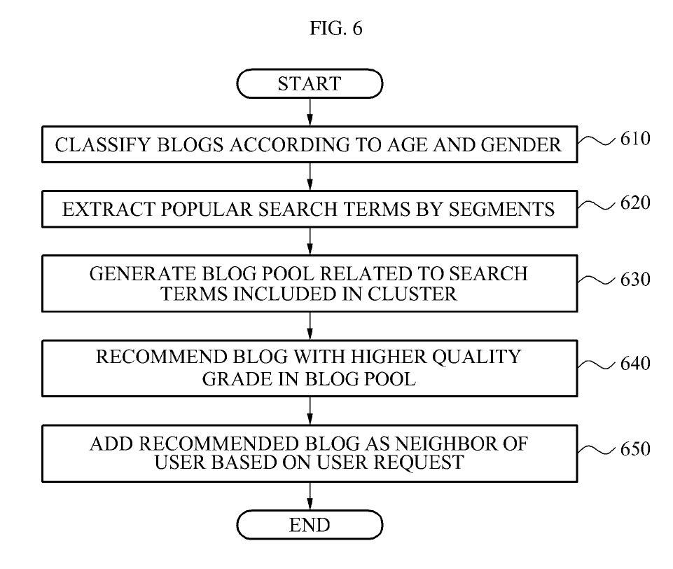

FIG. 6 is a flowchart of a process for illustrating a blog recommendation method which recommends a blog related to an interest by an age and a gender of a user according to exemplary embodiments of the present invention. Each process of the blog recommendation method may be conducted by the blog recommendation system 200 described with reference to FIG. 2.

In operation 610, the blog recommendation system 200 classifies blogs according to at least one category of an age and a gender. For example, the blog recommendation system 200 may classify blogs according to a gender into a blog group of female bloggers and a blog group of male bloggers, and further classify each blog group according to an age into a blog group of pre-teen bloggers, a blog group of bloggers in their twenties, and the like.

In operation 620, the blog recommendation system 200 may extract search terms continuously retrieved by users corresponding to certain age and/or gender in order to analyze interests of the users by categories. Here, the blog recommendation system 200 may extract a popular search term input a number of times greater than or equal to a predetermined number of times among search terms input by the users over a certain period of recent time. In order words, the blog recommendation system 200 may extract popular search terms continuously retrieved over a period of recent time using a cumulative query count by period for which a keyword is input in a search window of a search service. For example, a seasonal search term may intensively be retrieved for a short term or a temporarily popular search term may be excluded from the popular search terms.

And, the blog recommendation system 200 may acquire the search terms extracted by categories into a document in a blog corresponding to a segment of a corresponding category and group the terms into at least one cluster. For example, the blog recommendation system 200 may group the search terms into a cluster based on a repeated display count, that is, a number of times the search terms are repeated in documents which include common search terms. For example, the blog recommendation system 200 may multiply a repeated display count, that is, a number of times a search term is repeated in documents which include the same search term by a total number of documents in the same segment, divide a resulting value by a number of the documents which include the same search term, and group search terms having a resulting grade greater than or equal to a threshold value in the same cluster.

In operation 630, the blog recommendation system 200 may generate a blog pool related to a search term included in a cluster with respect to a category of an age and/or a gender. The blog recommendation system 200 may generate a blog pool with respect to a category by extracting blogs which have documents including more search terms included in the cluster and are aligned with respect to one subject. For example, the blog recommendation system 200 may generate a blog pool by extracting blogs in which at least a certain proportion of keywords found in documents correspond to search terms included in one cluster.

In operation 640, the blog recommendation system 200 may determine at least one blog from the blog pool as a recommended blog and provide the determined recommended blog to a user. The blog recommendation system 200 may calculate a quality grade of each blog included in the blog pool and determine a recommended blog based on the quality grade. For example, the blog recommendation system 200 may calculate a quality grade of a blog using at least one of a number of neighbors adding the blog as a neighbor and a frequency of updating content in the blog. In determining a recommended blog, the blog recommendation system 200 may determine blogs having a quality grade of a threshold value or higher from the blog pool to be recommendations and provide at least one of the recommendations as a recommended blog. Alternatively, the blog recommendation system 200 may determine at least one blog with a higher quality grade from the blog pool as a recommendation and provide the recommendation as a recommended blog. Further, the blog recommendation system 200 may determine a blog which allows selection as a recommended blog from the blog pool to be a recommendation. The blog recommendation system 200 may display a list of recommended blogs through a neighbor news page displaying a record of activities of a user with respect to a neighbor blog or the list directly through a recommended neighbor page displaying a list of recommended neighbor blogs. For example, the blog recommendation system 200 may display the list of the recommended blogs in descending order of higher quality grades and further display blog information on a recommended neighbor blog and a neighbor add menu for setting up a neighbor relationship in each item of the list.

In operation 650, when a user makes a request for setting up a neighbor relationship with respect to a recommended blog, the blog recommendation system 200 may set up a neighbor relationship between the recommended blog and the user and add the recommended blog as a neighbor blog of the user.

For example, a new blog recommending logic which recommends a blog about an interest by an age and a gender may be used to effectively select a recommended blog, thereby expanding a neighbor network of the user. Furthermore, continual interests by an age and a gender are extracted based on search terms, and a blog to be recommended to a user is determined based on interest matching and a quality grade of a blog, thereby recommending a blog suitable for the user.

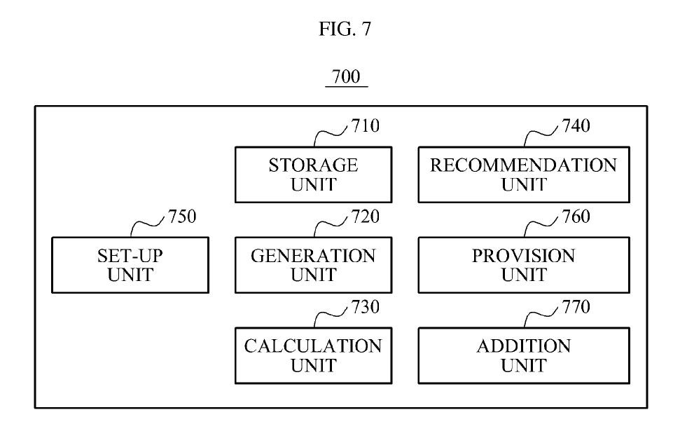

FIG. 7 is a block diagram illustrating a configuration of a blog recommendation system which recommends a blog having a similar behavior pattern to that of a user according to the exemplary embodiments of the present invention. The blog recommendation system 700 according to the exemplary embodiments includes a storage unit 710, a generation unit 720, a calculation unit 730, a recommendation unit 740, a set-up unit 750, a provision unit 760, and an addition unit 770.

The storage unit 710 may store a post in one blog read by each blogger having another blog and a retention time, that is, a measure of time spent by each blogger on the one blog. For example, the storage unit 170 may store and retain posts read by bloggers and a retention time corresponding to blogs over a recent period of time, for example, 30 days or 60 days, in connection to each blogger. The storage unit 710 may update and manage read posts and the retention time for each blog visited by each blogger, over a predetermined period of time.

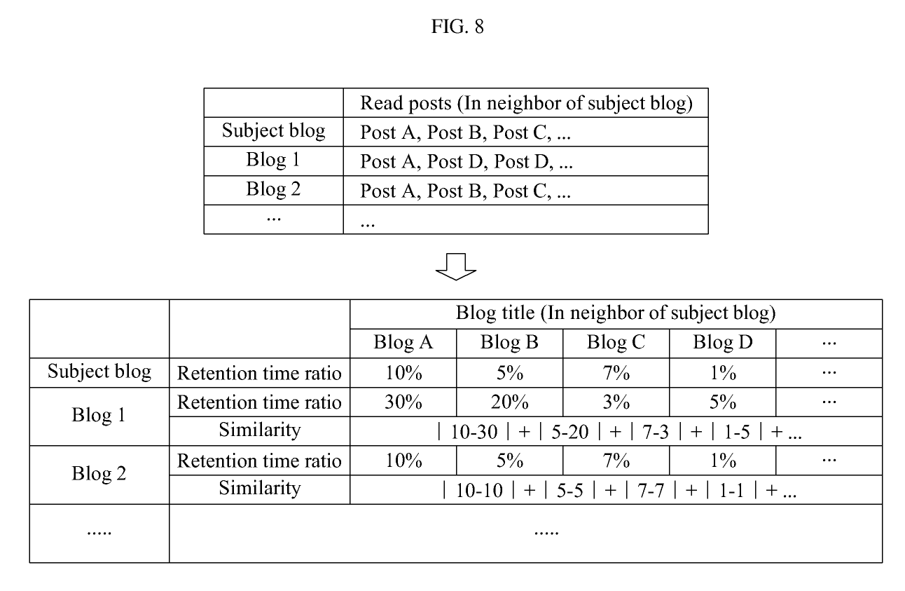

The generation unit 720 may generate a blog pool by extracting a blog having a similar interest to that of a subject blog, that is, a user, through comparison of posts read by bloggers based on the information stored in the storage unit 710. That is, the generation unit 720 may compare posts read by bloggers over a recent period of time with posts read by the user and extract blogs of bloggers reading at least a certain proportion, for example, 80% or higher, of the posts read by the user, thereby generating a blog pool. As shown in an upper table of FIG. 8, the blog pool includes blogs of bloggers recently reading at least a certain proportion of the same posts read by the user. That is, in the upper table of FIG. 8, the subject blog may be a user blog, and blogs 1 and 2, and the like, may be blogs of bloggers recently reading at least a portion of the same posts recently read by the user. Further, the generation unit 720 may generate a blog pool by comparing posts on a neighbor blog set up as a neighbor relationship with the user read by the user and other bloggers. Here, the neighbor relationship may include at least one of a me-added neighbor, a neighbor adding me, and a mutual or reciprocal neighbor. In other words, the generation unit 720 may extract blogs which are not set up as a neighbor relationship with the user but have a similar behavior pattern to that of the user in neighbor blogs of the user, thereby generating a blog pool.

The calculation unit 730 may calculate behavioral similarity between a blog included in the blog pool and the user using the retention time of visited blogs based on the information stored in the storage unit 710. For example, as shown in a lower table of FIG. 8, the calculation unit 730 may calculate an absolute value of a difference between a ratio of retention time in each blog visited by the user and a ratio of retention time in each blog visited by a blogger included in the blog pool and sum the values, thereby calculating the behavioral similarity. Here, the ratio of retention time in each blog may mean a ratio of retention time in the blog to total retention time stored for a recent period of time, and the behavioral similarity may be calculated using a retention time of each blog over the same period, with respect to a blog included in the blog pool and the user. As shown in FIG. 8, when the user and the blog 2 each have a retention time ratio of 10%, 5%, 7%, 1%, with respect to visited blogs A, B, C, D, and the blog 1 has a retention time ratio of 30%, 20%, 3%, 5%, with respect to the aforementioned blogs, a behavioral similarity between the user and the blog 1 is |10−30|+|5−20|+|7−3|+|1−5|, and a behavioral similarity between the user and the blog 2 is |10−10|+|5−5|+|7−7|+|1−1|. Here, the blogs A, B, C, D, may be neighbor blogs of the user. The lower the behavioral similarity calculated by the calculation unit 730 is, the more similar the behavioral pattern in a blog service blogs.

The recommendation unit 740 may provide a user with a blog included in the blog pool as a recommended blog based on the behavioral similarity. The recommendation unit 740 may determine subject blogs to be provided as a recommended blog to the user and order of the blogs based on the behavioral similarity. For example, the recommendation unit 740 may determine blogs having a behavioral similarity of a predetermined level or less, for example, 20% or less, in the blog pool to be recommendations and provide at least one of the recommendations as a recommended blog. Alternatively, the recommendation unit 740 may determine at least one blog having a lower behavioral similarity from the blog pool as a recommendation and provide the recommendation as a recommended blog. Further, the recommendation unit 740 may determine a blog which allows selection as a recommended blog from the blog pool as a recommendation. Accordingly, the set-up unit 750 sets up whether to selection as a recommended blog is allowed in association with each blog, based on a request of a blogger. Here, when a blogger prefers his/her blog not be selected as a recommended blog, the set-up unit 750 may provide an option which enables the blog not to be included in a neighbor recommendation pool. That is, the recommendation unit 740 may select a recommendation among blogs which allow selection as recommended blogs, excluding a blog which a user prefers not to be selected as a recommended blog in the blog pool. The recommendation unit 740 may determine a recommendation having a similar behavior pattern in a blog service to that of the user in the blog pool based on the behavioral similarity and provide the user with the determined blog as a recommended blog.

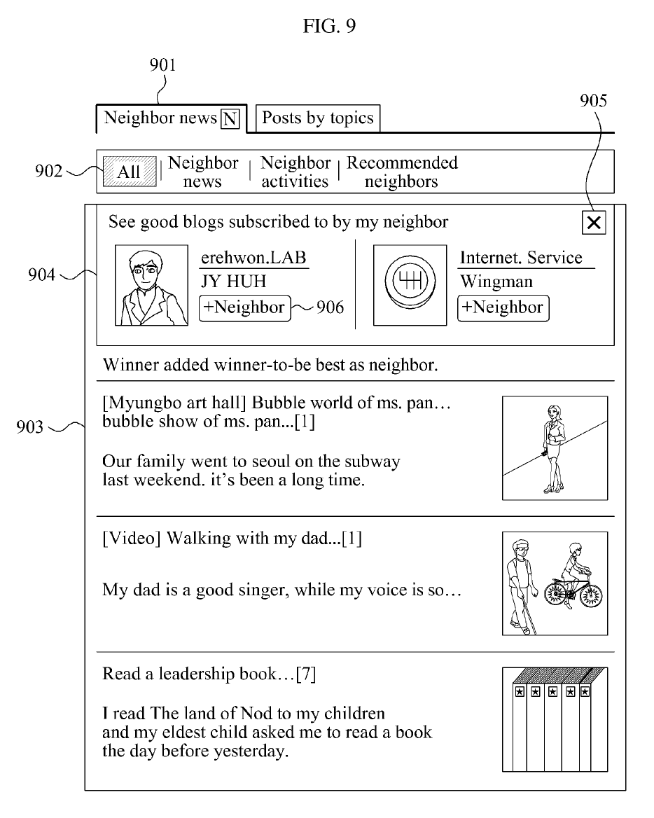

The provision unit 760 may provide a neighbor news page displaying a record of activities of the user with respect to a neighbor blog. For example, the neighbor news page may be a webpage providing a list of neighbor blogs having a record of recent activities and information on a corresponding neighbor blog, for example, a blog name, a blogger nickname and a recently updated post, in order to easily identify a record of activities of a neighbor blog set up as a neighbor relationship with the user and to facilitate visit to a neighbor blog. For example, the recommendation unit 740 may display a list of recommended blogs through the neighbor news page, on which the list of the recommended blogs among recommendations may be displayed in order of lower behavioral similarity or only a predetermined number of some blogs having a lower behavioral similarity may be displayed on the list of the recommended blogs. For example, as shown in FIG. 9, an ‘All’ menu 902 corresponding to a view all is selected on a neighbor news tab 901 providing the neighbor news page, the neighbor news tab 901 may provide a neighbor news section 903 displaying a record of activities in a neighbor blog and a recommended neighbor section 904 displaying blog information on a recommended blog. Here, the recommended neighbor section 904 may be displayed on a top of the neighbor news section 903. The blog information displayed on the recommended neighbor section 904 may include at least one of a blog name or nickname, a blog title, a profile image, a recently registered content, and a frequently registered topic or tag in registering content. The recommended neighbor section 904 may be initially displayed in a spread view and provide an icon 905 to support a fold or close feature, and a neighbor add menu 906 for setting up a neighbor relationship with a recommended blog. Further, when folded, the recommended neighbor section 904 may be displayed as a one-line message or an icon indicating that the section 904 is an area where a recommended blog is displayed.

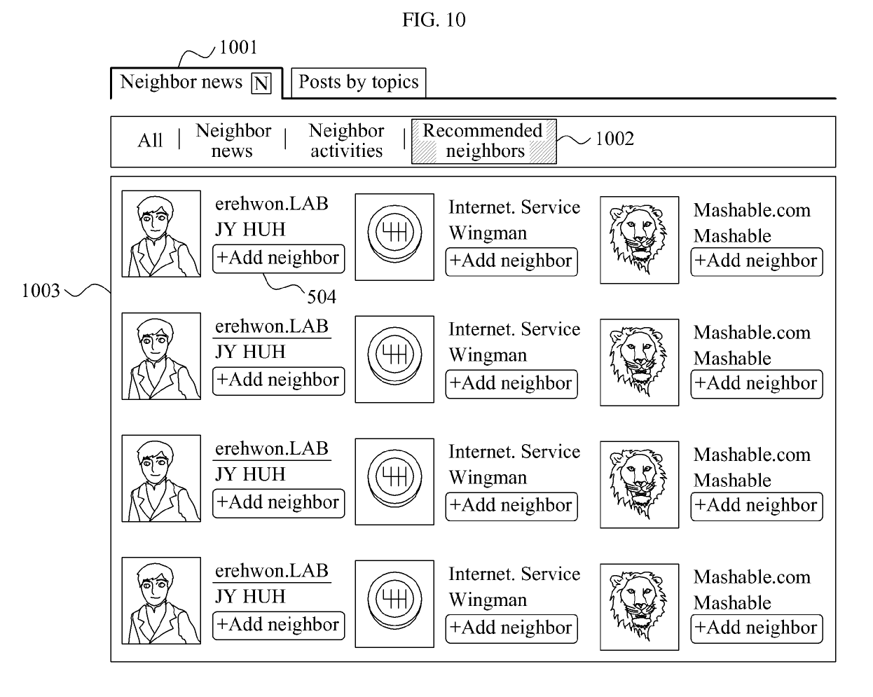

As an example, the provision unit 760 may provide a recommended neighbor page displaying a list of recommended blogs. For example, the recommended neighbor page may be a webpage offering a list of recommended blogs and blog information so that the user may easily identify a subject or context of a recommended blog. In this example, the recommendation unit 740 may display the list of the recommended blogs through the recommended neighbor page, on which all blogs determined to be recommendations may be displayed on the list in ascending order of behavioral similarity. For example, as shown in FIG. 10, when a ‘Recommended Neighbor’ menu 1002 is selected, to view of a recommended neighbor page on a neighbor news tab 1001 providing a neighbor news page, the neighbor news tab 1001 may provide a recommended neighbor section 1003 displaying a list of recommended blogs and blog information. Here, the blog information displayed on the recommended neighbor section 1003 may include at least one of a blog name or nickname, a blog title, a profile image, a recently registered content, and a frequently registered topic or tag in registered content. For example, among the blog information, a blog name or nickname, a blog title, and a profile image may be essentially displayed, and a recently registered content and a frequently registered topic or tag in registered content may be additionally displayed. In addition, the recommended neighbor section 1003 may provide a neighbor add menu 1004 for setting up a neighbor relationship with a recommended blog.

The addition unit 770 may set up a neighbor relationship between a recommended blog and a user, when the user makes a request for setting up a neighbor relationship with the recommended blog, and may add the recommended blog as a neighbor blog of the user.

The blog recommendation system 700 having the foregoing configuration may recommend a blog having a similar behavior pattern in the blog service to that of the user based on the behavioral similarity between bloggers. Here, the behavioral similarity, which is obtained using the retention time of recently visited blogs and read posts in the blogs, may be used to select and recommend a blog appropriate for the user.

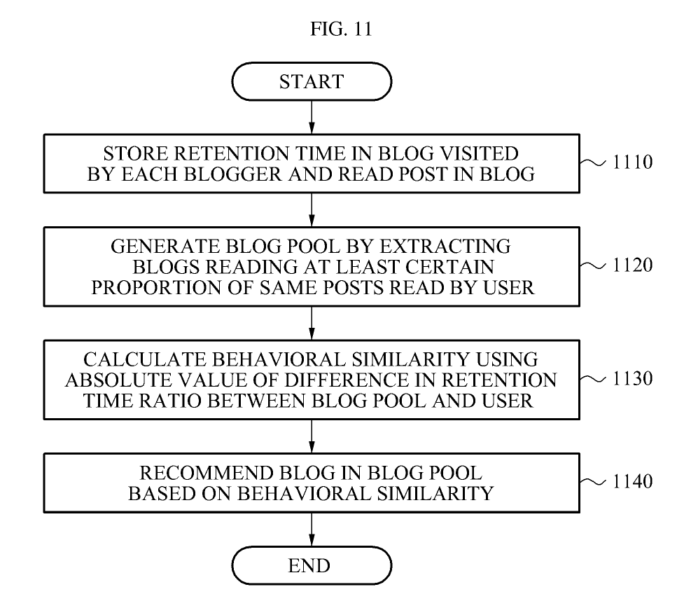

FIG. 11 is a flowchart of a process for illustrating a blog recommendation method which recommends a blog having a similar behavior pattern to that of a user according to exemplary embodiments. Each process of the blog recommendation method may be carried out by the blog recommendation system 700 described with reference to FIG. 7.

In operation 1110, the blog recommendation system 700 may store a post in one blog read by each blogger having another blog and retention time that is a measure of how long each blogger stays in the one blog. The blog recommendation system 700 may store and retain posts read by bloggers and a retention time in corresponding blogs for a period of recent time in connection to each blogger, and update and manage the read posts and the retention time over a predetermined period of time.

In operation 1120, the blog recommendation system 700 may generate a blog pool by extracting a blog having a similar interest to that of a user through comparison of posts read by bloggers based on the information stored in operation 1110. For example, the blog recommendation system 700 may compare posts read by bloggers for a period of recent time with posts read by the user and extract blogs of bloggers reading at least a certain proportion of the posts read by the user, thereby generating a blog pool. For example, the blog recommendation system 700 may generate a blog pool by comparing posts on a neighbor blog set up as a neighbor relationship with the user read by the user and other bloggers.

In operation 1130, the blog recommendation system 700 may calculate behavioral similarity between a blog included in the blog pool and the user using retention time by visited blogs based on the information stored at operation 1110. For example, the blog recommendation system 700 may calculate an absolute value of a difference between a ratio of retention time for each blog visited by the user and a ratio of retention time for each blog visited by a blogger included in the blog pool and sum the values, thereby calculating the behavioral similarity. Here, is the ratio of retention time for each blog may refer to a ratio of retention time for the blog to total the retention time stored for a recent period of time, and the behavioral similarity may be calculated using the retention time in each blog over the same period with respect to a blog included in the blog pool and the user.

In operation 1140, the blog recommendation system 700 may provide a user with a blog included in the blog pool as a recommended blog based on the behavioral similarity. That is, the blog recommendation system 700 may determine subject blogs to be provided as a recommended blog to the user and orders of the blogs based on the behavioral similarity. For example, the blog recommendation system 700 may determine blogs having a behavioral similarity less than or equal to a predetermined level in the blog pool as recommendations and provide at least one of the recommendations as a recommended blog. Alternatively, the blog recommendation system 700 may determine at least one blog having a lower behavioral similarity from the blog pool as a recommendation and provide the recommendation as a recommended blog. Further, the blog recommendation system 700 may determine a blog which allows selection as a recommended blog from the blog pool as a recommendation. In addition, the blog recommendation system 700 may display a list of recommended blogs through a neighbor news page displaying a record of activities of the user with respect to a neighbor blog or directly display the list of the recommended blogs through a recommended neighbor page displaying the list of the recommended blogs. For example, the blog recommendation system 700 may display the list of the recommended blogs in order of lower behavioral similarity and further display blog information on a recommended neighbor blog and a neighbor add menu for setting up a neighbor relationship in each item of the list. When the user makes a request for setting up a neighbor relationship with a recommended blog, the blog recommendation system 700 may set up a neighbor relationship between the recommended blog and the user and add the recommended blog as a neighbor blog of the user.

According to the exemplary embodiments, a new blog recommending logic which recommends a blog having a similar behavior pattern in a blog service to that of the user may be used to effectively select a recommended blog, thereby expanding a neighbor network of the user. Furthermore, a blog having a similar behavior pattern in a blog service to that of the user is recommended using posts read by bloggers and retention time ratios by blogs, thereby providing a blog suitable for the user.

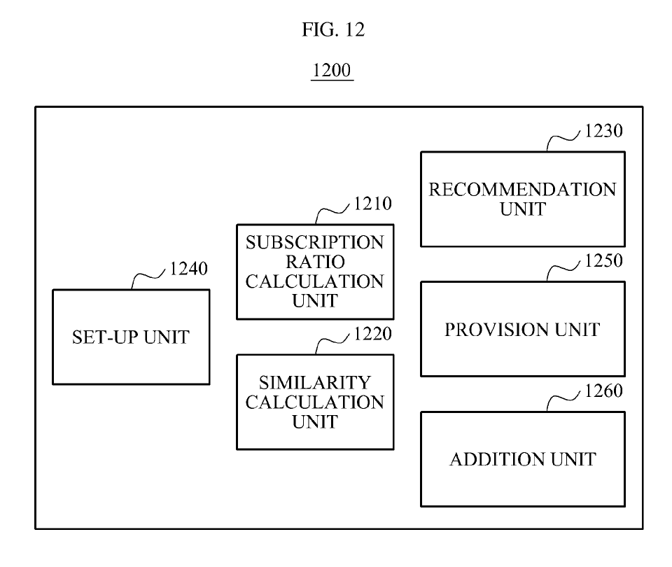

FIG. 12 is a block diagram illustrating a configuration of a blog recommendation system which recommends blogs having similar category-specific distributions of community services subscribed to, according to the exemplary embodiments of the present invention. The blog recommendation system 1200 according to the exemplary embodiments may include a subscription ratio calculation unit 1210, a similarity calculation unit 1220, a recommendation unit 1230, a set-up unit 1240, a provision unit 1250, and an addition unit 1260.

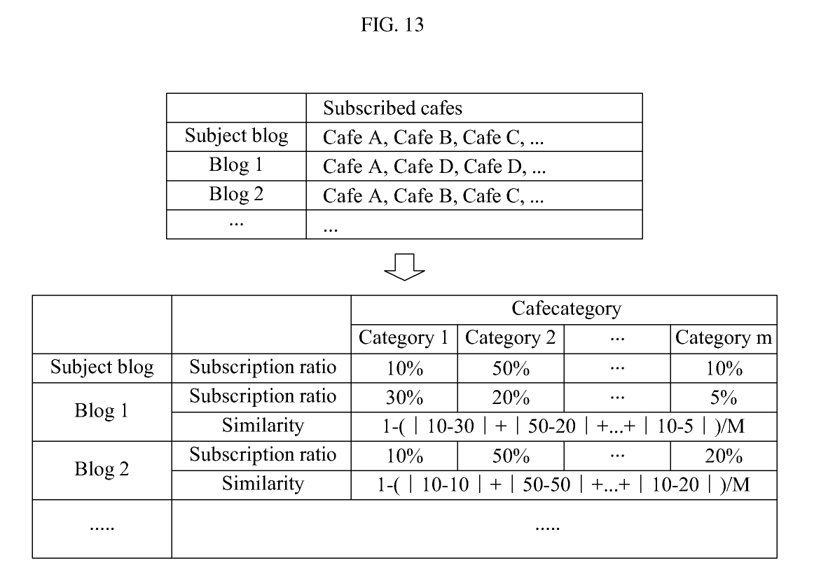

The subscription ratio calculation unit 1210 may calculate a service subscription ratio of each blogger having a blog with respect to a café in each category, on which cafés are classified. For example, a community server may manage cafés classified according to twenty six (26) categories, for example, games, comics/animations, broadcast news/entertainment programs, culture/art, movies, music, fan cafés, travel, sports/leisure, pets, hobbies, living, fashion/beauty, health/diet, family/childcare, computer/communications, education, languages, liberal arts/science, economics/finance, politics/society, literature/writing, alumni/classmates, friendship/clubs, religions/voluntary work, and Junior Naver. For example, as shown in an upper table of FIG. 13, the community server may categorize and retain information on cafés subscribed to by each blog, for example, a café name and a café category. The subscription ratio calculation unit 1210 may calculate a service subscription ratio by category for each blogger with respect to cafés subscribed to by each blogger, in association with the community server. For example, the subscription ratio calculation unit 1210 may calculate a ratio of cafés subscribed to in each category, on which the community server classifies cafés with respect to all cafés subscribed to by a blogger. A service subscription ratio in each category may be defined by the following Equation 3.

Service subscription ratio in category 1=Number of cafés subscribed to in category 1/Total number of cafés subscribed to,

Service subscription ratio in category 2=Number of cafés subscribed to in category 2/Total number of cafés subscribed to,

. . . ,

Service subscription ratio in category m=Number of cafés subscribed to in category m/Total number of cafés subscribed to. [Equation 3]

The similarity calculation unit 1220 may calculate community similarity by comparing service subscription ratios in each category between a subject blogger, that is, a user, and another blogger. As shown in a lower table of FIG. 13, the similarity calculation unit 1220 may calculate the community similarity using a difference in service subscription ratio in each category between the user and the other blogger. In the exemplary embodiments, the community similarity between the user that is a blogger 0 and another blogger, that is, a blogger 1 may be defined by the following Equation 4.

Community similarity (0 to 100%)=1−(|service subscription ratio in category 1 of blogger 0−service subscription ratio in category 1 of blogger 1|+|service subscription ratio in category 2 of blogger 0−service subscription ratio in category 2 of blogger 1|+ . . . +|service subscription ratio in category m of blogger 0−service subscription ratio in category m of blogger 1|)/M [Equation 4]

Here, M denotes a number of categories. As shown in the Equation 4, the similarity calculation unit 1220 may sum absolute values of differences between a service subscription ratio in each category of the user and a service subscription ratio in each category of the other blogger, thereby calculating the community similarity between the user and the other blogger.

The recommendation unit 1230 may provide the user with a blog of the other blogger as a recommended blog based on the community similarity. The recommendation unit 1230 may determine subject blogs to be provided as a recommended blog to the user and an order of the blogs based on the community similarity. For example, the recommendation unit 1230 may determine blogs having a community similarity greater than or equal to a predetermined level, for example, 80% or higher, as recommendations and provide at least one of the recommendations as a recommended blog. Alternatively, the recommendation unit 1230 may determine at least one blog having a higher community similarity as a recommendation and provide the recommendation as a recommended blog. Further, the recommendation unit 1230 may determine a blog which allows selection as a recommended blog among other blogs as a recommendation. Accordingly, the set-up unit 1240 sets up whether selection as a recommended blog is allowed in association with each blog, based on a request of a blogger. For example, when a blogger prefers that his/her blog not be selected as a recommended blog, the set-up unit 1240 may provide an option which enables the blog to be excluded from a neighbor recommendation pool. For example, the recommendation unit 1230 may select a recommendation among blogs which allow selection as recommended blogs, excluding a blog which a user prefers not to be selected as a recommended blog among other blogs. The recommendation unit 1230 may determine a recommendation having similar interest similarity to that of the user among other blogs based on the community similarity and provide the user with the determined blog as a recommended blog.

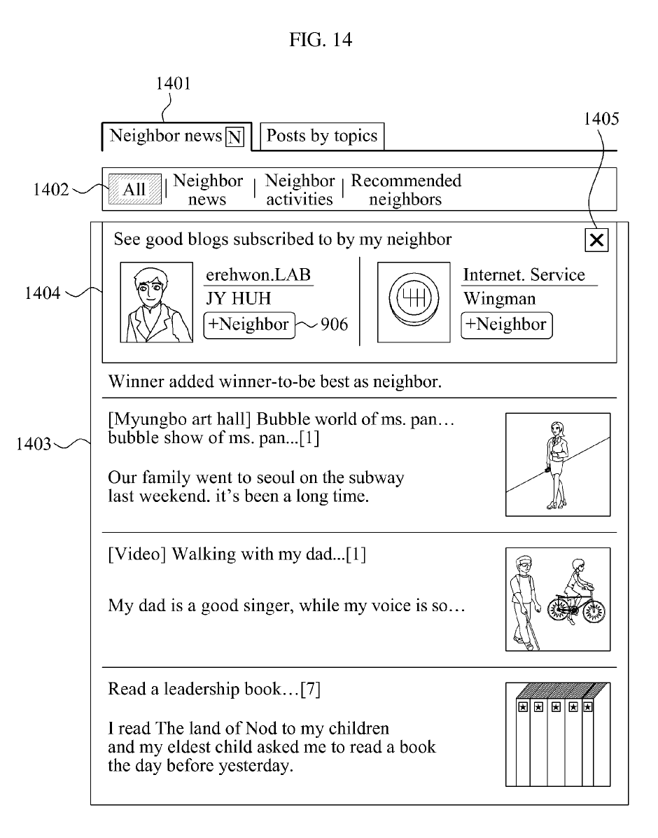

The provision unit 1250 may provide a neighbor news page displaying a record of activities of the user with respect to a neighbor blog. Here, the neighbor news page may be a webpage providing a list of neighbor blogs having a record of recent activities and information on a corresponding neighbor blog, for example, a blog name, a blogger nickname and a recently updated post, in order to easily identify a record of activities of a neighbor blog set up as a neighbor relationship with the user and to facilitate visit to a neighbor blog. For example, the recommendation unit 1230 may display a list of recommended blogs through the neighbor news page, on which the list of the recommended blogs may be displayed in descending order of community similarity or only a predetermined number of some blogs having a higher community similarity may be displayed on the list of the recommended blogs. For example, as shown in FIG. 14, an ‘All’ menu 1402 corresponding to a view all is selected on a neighbor news tab 1401 providing the neighbor news page, the neighbor news tab 1401 may provide a neighbor news section 1403 displaying a record of activities in a neighbor blog and a recommended neighbor section 1404 displaying blog information on a recommended blog. For example, the recommended neighbor section 1404 may be displayed on a top of the neighbor news section 1403, being included in the neighbor news section 1403. The blog information displayed on the recommended neighbor section 1404 may include at least one of a blog name or nickname, a blog title, a profile image, a recently registered content, and a frequently registered topic or tag in registering content. The recommended neighbor section 1404 may be initially displayed in a spread view and provide an icon 1405 to support a fold or close feature and a neighbor add menu 1406 for setting up a neighbor relationship with a recommended blog. Further, when folded, the recommended neighbor section 1404 may be displayed as a one-line message or an icon indicating that the section 904 is an area where a recommended blog is displayed.

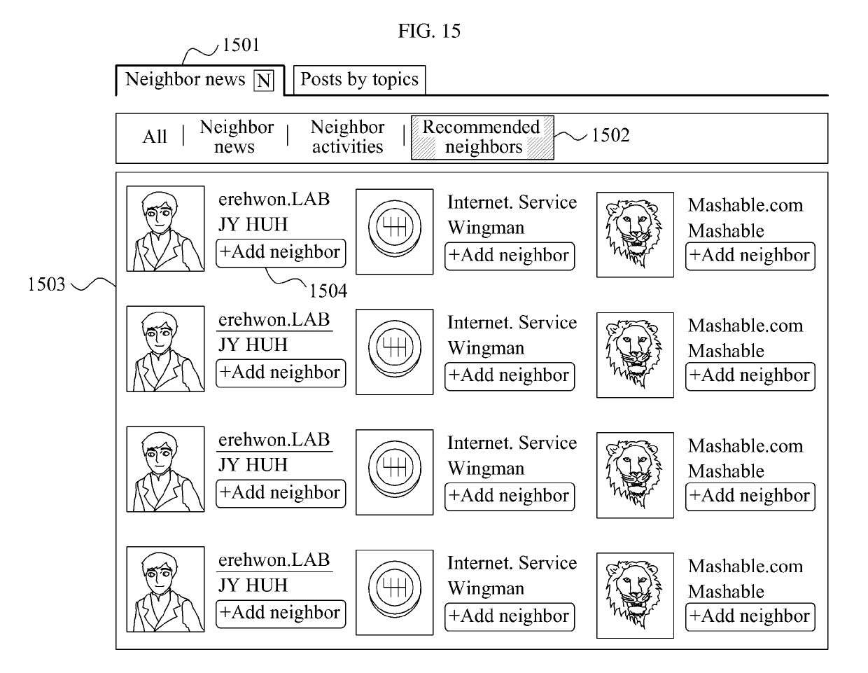

Further, the provision unit 1250 may provide a recommended neighbor page displaying a list of recommended blogs. For example, the recommended neighbor page may be a webpage offering a list of recommended blogs and blog information so that the user may easily identify a subject or context of a recommended blog. For example, the recommendation unit 1230 may display the list of the recommended blogs through the recommended neighbor page, on which all blogs determined as recommendations may be displayed on the list in order of higher community similarity. For example, as shown in FIG. 15, when a ‘Recommended Neighbor’ menu 1502 is selected, to view of a recommended neighbor page, on a neighbor news tab 1501 providing a neighbor news page, the neighbor news tab 1501 may provide a recommended neighbor section 1503 displaying a list of recommended blogs and blog information. For example, the blog information displayed on the recommended neighbor section 1503 may include at least one of a blog name or nickname, a blog title, a profile image, a recently registered content, and a frequently registered topic or tag in registering content. As an example, among the blog information, a blog name or nickname, a blog title, and a profile image may be essentially displayed, and a recently registered content and a frequently registered topic or tag in registering content may be additionally displayed. In addition, the recommended neighbor section 1503 may provide a neighbor add menu 1504 for setting up a neighbor relationship with a recommended blog.

The addition unit 1260 may set up a neighbor relationship between a recommended blog and a user, when the user makes a request for setting up a neighbor relationship with the recommended blog, and may add the recommended blog as a neighbor blog of the user.

The blog recommendation system 1200 with the foregoing configuration may estimate interest similarity using a category of cafés subscribed to, thereby recommending a blog having similar interests to those of the user. For example, the interest similarity may be estimated by comparing category-specific distributions of cafés subscribed to by bloggers.

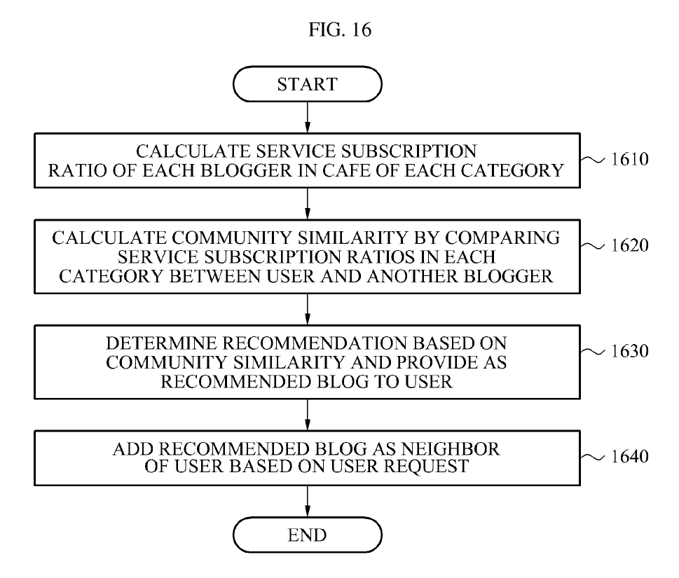

FIG. 16 is a flowchart of a process for illustrating a blog recommendation method which recommends a blog having similar category-specific distribution of community services subscribed to, according to the exemplary embodiments. Each process of the blog recommendation method may be carried out by the blog recommendation system 1200 described with reference to FIG. 12.

In operation 1610, the blog recommendation system 1200 may calculate a service subscription ratio that is a ratio of cafés subscribed to by each blogger having a blog by categories, on which cafés are classified. The blog recommendation system 1200 may calculate a ratio of cafés subscribed to in each category, on which a community server classifies cafés, with respect to all cafés subscribed to by each blogger in association with the community server managing the cafés. To this end, the community server may categorize and retain information on cafés subscribed to by each blog, for example, a café name and a café category. In the exemplary embodiments, a service subscription ratio in each category may be defined as {number of cafés subscribed to in category 1/total number of cafés subscribed to, number of cafés subscribed to in category 2/total number of cafés subscribed to, . . . , number of cafés subscribed to in category m/total number of cafés subscribed to}.

In operation 1620, the blog recommendation system 1200 may calculate community similarity by comparing service subscription ratios in each category between a user and another blogger. For example, the blog recommendation system 1200 may add up absolute values of differences between a service subscription ratio in each category of the user and a service subscription ratio in each category of the other blogger, thereby calculating the community similarity between the user and the other blogger. In the exemplary embodiments, the community similarity, for example 0 to 100%, between the user, that is, a blogger 0 and another blogger, that is, a blogger 1 may be defined by {1−(|service subscription ratio in category 1 of blogger 0−service subscription ratio in category 1 of blogger 1|+|service subscription ratio in category 2 of blogger 0−service subscription ratio in category 2 of blogger 1|+ . . . +|service subscription ratio in category m of blogger 0−service subscription ratio in category m of blogger 1|)/M}.

In operation 1630, the blog recommendation system 1200 may provide the user with a blog of the other blogger as a recommended blog based on the community similarity. That is, the blog recommendation system 1200 may determine subject blogs to be provided as a recommended blog to the user and order of the blogs based on the community similarity. For example, the blog recommendation system 1200 may determine blogs having a community similarity of a predetermined level or higher as recommendations and provide at least one of the recommendations as a recommended blog. Alternatively, the blog recommendation system 1200 may determine at least one blog having a higher community similarity to be a recommendation and provide the recommendation as a recommended blog. Further, the blog recommendation system 1200 may determine a blog which allows selection as a recommended blog among other blogs as a recommendation. In addition, the blog recommendation system 1200 may display a list of recommended blogs through a neighbor news page displaying a record of activities of the user with respect to a neighbor blog or display the list of the recommended blogs directly through a recommended neighbor page displaying the list of the recommended blogs. For example, the blog recommendation system 1200 may display the list of the recommended blogs in ascending order of community similarity and further display blog information on a recommended neighbor blog, and a neighbor add menu for setting up a neighbor relationship in each item of the list.

In operation 1640, when the user makes a request for setting up a neighbor relationship with a recommended blog, the blog recommendation system 1200 may set up a neighbor relationship between the recommended blog and the user and add the recommended blog as a neighbor blog of the user.

According to the exemplary embodiments, a new blog recommending logic which recommends a blog having a similar interest to that of the user may be used to effectively select a recommended blog, thereby expanding a neighbor network of the user. Furthermore, a blog having similar interests to those of the user is recommended by estimating interest similarity between bloggers using a category of cafés subscribed to by the bloggers, thereby providing a blog suitable for the user.

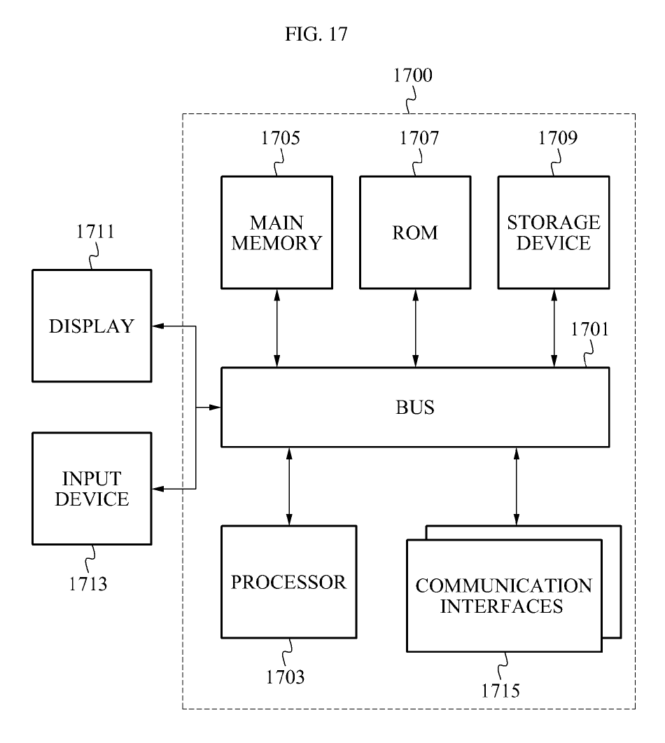

One of ordinary skill in the art would recognize that system and method for recommending blog may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 17.

FIG. 17 illustrates exemplary hardware upon which various embodiments of the invention can be implemented. A computing system 1700 includes a bus 1701 or other communication mechanism for communicating information and a processor 1703 coupled to the bus 1701 for processing information. The computing system 1700 also includes main memory 1705, such as a random access memory (RAM) or other dynamic storage device, coupled to the bus 1701 for storing information and instructions to be executed by the processor 1703. Main memory 1705 can also be used for storing temporary variables or other intermediate information during execution of instructions by the processor 1703. The computing system 1700 may further include a read only memory (ROM) 1707 or other static storage device coupled to the bus 1701 for storing static information and instructions for the processor 1703. A storage device 1709, such as a magnetic disk or optical disk, is coupled to the bus 1701 for persistently storing information and instructions.

The computing system 1700 may be coupled with the bus 1701 to a display 1711, such as a liquid crystal display, or active matrix display, for displaying information to a user. An input device 1713, such as a keyboard including alphanumeric and other keys, may be coupled to the bus 1701 for communicating information and command selections to the processor 1703.

The input device 1713 can include a cursor control, such as a mouse, a trackball, or cursor direction keys, for communicating direction information and command selections to the processor 1703 and for controlling cursor movement on the display 1711.

According to various embodiments of the invention, the processes described herein can be provided by the computing system 1700 in response to the processor 1703 executing an arrangement of instructions contained in main memory 1705. Such instructions can be read into main memory 1705 from another computer-readable medium, such as the storage device 1709. Execution of the arrangement of instructions contained in main memory 1705 causes the processor 1703 to perform the process steps described herein. One or more processors in a multi-processing arrangement may also be employed to execute the instructions contained in main memory 1705. In alternative embodiments, hard-wired circuitry may be used in place of or in combination with software instructions to implement the embodiment of the invention. In another example, reconfigurable hardware such as Field Programmable Gate Arrays (FPGAs) can be used, in which the functionality and connection topology of its logic gates are customizable at run-time, typically by programming memory look up tables. Thus, embodiments of the invention are not limited to any specific combination of hardware circuitry and software.

The computing system 1700 also includes at least one communication interface 1715 coupled to bus 1701. The communication interface 1715 provides a two-way data communication coupling to a network link (not shown). The communication interface 1715 sends and receives electrical, electromagnetic, or optical signals that carry digital data streams representing various types of information. Further, the communication interface 1715 can include peripheral interface devices, such as a Universal Serial Bus (USB) interface, a PCMCIA (Personal Computer Memory Card International Association) interface, etc.

The processor 1703 may execute the transmitted code while being received and/or store the code in the storage device 1709, or other non-volatile storage for later execution. In this manner, the computing system 1700 may execute an application.

The term “computer-readable medium” or “storage device” as used herein refers to any medium that participates in providing instructions to the processor 1703 for execution.

Such a medium may take many forms, including but not limited to non-volatile media, volatile media, and transmission media. Non-volatile media include, for example, optical or magnetic disks, such as the storage device 1709. Volatile media include dynamic memory, such as main memory 1705. Transmission media include coaxial cables, copper wire and fiber optics, including the wires that comprise the bus 1701. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone or cable line. A modem of a local system receives the data on the telephone line and uses a wireless transmitter to convert the data to a signal and transmit the signal to a portable computing device, such as a personal digital assistant (PDA) or a laptop. A detector on the portable computing device receives the information and instructions borne by the signal and places the data on a bus. The bus conveys the data to main memory, from which a processor retrieves and executes the instructions. The instructions received by main memory can optionally be stored on storage device either before or after execution by processor. One or more units associated with a processor or computing device are configured to perform an operation of the exemplary embodiments. These units can be self-contained units or hardware components, such as an assembly of electronic components, a computing embedded system, a computer module, or computer software modules which can perform a defined task executable by the processor or the computing device and can be linked with other units or components to form a larger system.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A system for recommending a blog, the system comprising:
a segmentation unit configured to classify blogs according to at least one category of an age and a gender of a user;
an extraction unit configured to extract a plurality of search terms retrieved by a user corresponding to the category;
a cluster unit configured to collect the search terms into a document in the classified blogs and to group the search terms into at least one cluster;
a generation unit configured to generate a blog pool related to the search terms of the cluster; and
a recommendation unit configured to provide the user with at least one blog in the blog pool as a recommended blog.

2. The system of claim 1, wherein the extraction unit is configured to extract a popular search term input if a number of times of the search term input greater than or equal to a predetermined number of times among search terms recently input by the user over a certain period of time, and to exclude a seasonal search term or a temporarily popular search term from the popular search term.

3. The system of claim 1, wherein the cluster unit is configured to group the search terms into a cluster based on a repeated display count which comprises a number of times of the search terms being repeated in documents which include common search terms.

4. The system of claim 1, wherein the generation unit is configured to generate the blog pool by extracting blogs which comprise documents comprising the search terms of the cluster.

5. The system of claim 1, wherein the recommendation unit is configured to calculate a quality grade of a blog of the blog pool using at least one of a number of neighbors adding the blog as a neighbor or a frequency of updating content in the blog, to determine a blog comprising the quality grade greater than or equal to a threshold value or at least one blog having a higher quality grade than other blogs of the blog pool to be a recommendation, and to provide the recommendation as the recommended blog.

6. The system of claim 1, wherein the system further comprises a set-up unit configured to set up whether selection as the recommended blog is allowed based on a request of a blogger, and
the recommendation unit is configured to provide a blog which allows selection to be the recommended blog as the recommended blog.

7. The system of claim 1, wherein the system further comprises a provision unit configured to provide a neighbor news page comprising a web page to display a record of activities of a neighbor blog set up as a neighbor relationship with the user, and
the recommendation unit is configured to display a list of the recommended blog through the neighbor news page.

8. The system of claim 1, wherein the system further comprises a provision unit configured to provide a recommended neighbor page comprising a web page configured to display a list of the recommended blog, and
the recommendation unit is configured to display a list of the recommended blog through the recommended neighbor page.

9. The system of claim 1, wherein the system further comprises an addition unit configured to add the recommended blog as a neighbor blog of the user in response to detection of a request by the user for setting up a neighbor relationship with the recommended blog.

10. A system for recommending a blog, the system comprising:
a storage device configured to store posts in one blog read by each blogger comprising another blog and a retention time which comprises a measure of time spent by each blogger in the one blog;
a generation unit configured to compare read posts with posts read by a user and configured to generate a blog pool comprising the read posts similar to the posts read by the user;
a calculation unit configured to calculate behavioral similarity between a blog of the blog pool and the user using the retention time; and
a recommendation unit configured to provide the user with a blog of the blog pool as a recommended blog based on the behavioral similarity.

11. The system of claim 10, wherein the generation unit is configured to extract blogs of the same posts read by the user among the blogs and to generate the blog pool.

12. The system of claim 10, wherein the calculation unit is configured to calculate the behavioral similarity by calculating the difference between a ratio of retention time of the user in a different blog and a ratio of retention time of each blog of the blog pool in the different blog.

13. The system of claim 12, wherein the recommendation unit is configured to determine a blog comprising the behavioral similarity less than or equal to a predetermined level or at least one blog comprising a lower behavioral similarity as a recommendation, and to provide at least one of the recommendations as the recommended blog.

14. A system for recommending a blog, the system comprising:
a subscription ratio calculation unit configured to calculate a service subscription ratio of each blogger comprising a blog with respect to a community service in each category, wherein community services are classified;
a similarity calculation unit configured to calculate community similarity by comparing service subscription ratios in each category between a user that is a subject blogger and bloggers comprising a first blogger; and
a recommendation unit to provide the user with a blog of the first blogger as a recommended blog based on the community similarity.

15. The system of claim 14, wherein the subscription ratio calculation unit is configured to calculate the service subscription ratio in each category with respect to community services subscribed to by each blogger in association with the community server related to the community services, and
the service subscription ratio in each category is a ratio of community services corresponding to the category among the community services subscribed to by the blogger.

16. The system of claim 14, wherein the similarity calculation unit is configured to calculate the community similarity by summing absolute values of differences between a service subscription ratio in each category of the user and a service subscription ratio in each category of the first blogger.

17. The system of claim 16, wherein the recommendation unit is configured to determine a blog comprising the community similarity less than or equal to a predetermined level or at least one blog comprising a higher community similarity to be a recommendation, and to provide at least one of the recommendations as the recommended blog.

18. A method using a processor for recommending a blog, the method comprising:
classifying blogs according to at least one category of an age and a gender of a user;
extracting a plurality of search terms retrieved by a user corresponding to the category;
collecting, by the processor, the search terms into a document in the classified blogs for grouping the search terms into at least one cluster;
generating a blog pool related to the search terms of the cluster; and
providing the user with at least one blog in the blog pool as a recommended blog.

19. A method using a processor for recommending a blog, the method comprising:
storing posts in one blog read by each blogger comprising a first blog and a retention time of the each blogger stayed in the one blog;
comparing the posts with posts read by a user and generating a blog pool comprising the posts similar to the posts read by the user;
calculating, by the processor, behavioral similarity between a blog of the blog pool and the user using the retention time; and
providing the user with a blog of the blog pool as a recommended blog based on the behavioral similarity.

20. A method using a processor for recommending a blog, the method comprising:
calculating a service subscription ratio of each blogger comprising a blog with respect to a community service in each category, wherein community services are classified;
calculating, by the processor, community similarity by comparing service subscription ratios in each category between a user that is a subject blogger among the bloggers and a first blogger; and
providing the user with a blog of the first blogger as a recommended blog based on the community similarity.
